(19) United States
(12) Patent Application Publication
(10) Pub. No.: US 2008/0013765 A1
(43) Pub. Date: Jan. 17, 2008

(54) HINGE ASSEMBLY FOR A HEARING AID

(75) Inventors: Dennis Brian Nielsen, Vejby (DK); Jorgen Mejner Olsen, Hillerod (DK); Jan Topholm, Holte (DK)

Correspondence Address: SUGHRUE MION, PLLC, 2100 PENNSYLVANIA AVENUE, N.W., SUITE 800, WASHINGTON, DC, 20037, US

(73) Assignee: Widex A/S, Vaerlose (DK)

(21) Appl. No.: 11/832,454

(22) Filed: Aug. 1, 2007

Related U.S. Application Data
(63) Continuation-in-part of application No. PCT/DK2005/000076, filed on Feb. 3, 2005.

(51) Int. Cl. H04R 25/00

(52) U.S. Cl. 381/322

(57) ABSTRACT

A hinge assembly for a hearing aid, in particular for a lid of a battery compartment of a hearing aid, the hinge assembly including a first part, a second part and a third part including a shaft. The first part includes a pair for grooves adapted for receiving respective end parts of the shaft, both of the grooves being open at one end generally facing away from the battery compartment. The second part includes a through bore adapted for receiving a middle portion of the shaft between the respective end parts. The hinge assembly further includes a mechanism for closing the grooves at the open ends.

### RELATED APPLICATIONS

The present application is a continuation-in-part of application No. PCT/DK2005/000076, filed on Feb. 3, 2005, in Denmark and published as WO2006/081818 A1.

### BACKGROUND OF THE INVENTION

1. Field of the Invention

The present invention generally relates to a hearing aid. More specifically the invention relates to a hinge assembly for a hearing aid, in particular a hinge assembly for a lid of a battery compartment of a hearing aid. The invention also relates to a method for assembling such a hinge assembly.

2. The Prior Art

It is well known in the field of hearing aids to provide the ON/OFF switching function in connection with the battery compartment. An example can be found in U.S. Pat. No. 5,588,064.

Also, hearing aids, in which the battery compartment is fixed in the housing and covered by a pivotally movable lid are known. An example of such is found in U.S. Pat. No. 5,675,657, where, in one embodiment, the battery is inserted axially into the battery compartment and covered by a pivotally movable lid, which also serves as ON/OFF switch.

Having both the opening motion and the actuation motion for the off operation as the same motion, however, may be undesirable, because it involves the risk of opening the battery compartment entirely instead of simply interrupting the electric circuit. This may lead to the battery falling out and getting lost.

It is therefore desirable to provide the ON/OFF switching motion as a sliding motion of the movable lid, and the opening motion for removal of the battery as a pivotal motion.

Furthermore, in connection with pivotal lids for battery compartments it has been known to provide a metal shaft located in recesses in the hearing aid housing and passing through a bore in the lid. The use of a metal shaft in connection with the lid, however, has the drawback that if the lid is subjected to excessive forces, e.g. if the hearing aid is dropped and inadvertently stepped upon, the lid or even the housing of the hearing aid will break.

### SUMMARY OF THE INVENTION

It is an object of the present invention to provide a hinge assembly, in particular for a hearing aid, which provides the desired switching facilities and overcomes the above drawbacks.

The invention, in a first aspect, provides a hinge assembly for a lid of a battery compartment of a hearing aid, said hinge assembly comprising a first part, a second part and a third part, said third part having a shaft, said first part having a pair of grooves adapted for receiving respective end parts of said shaft, so as to allow the shaft to slide along the lengths of said grooves, both of said grooves being open at one end generally facing away from said battery compartment, said second part having a through bore adapted for receiving a portion of said shaft between said respective end parts, wherein a central part of said portion of said shaft has a larger cross-sectional dimension than said end parts, said central part having a cross-sectional dimension essentially corresponding to the cross-sectional dimension of said through bore and said end parts having a diameter corresponding essentially to the width of said grooves, and said hinge assembly further having means for limiting the linear motion of said end parts of said shaft in said grooves.

Such an assembly provides the possibility of having an easily removable shaft, for easy replacement in the event it should break. This is achieved because means for limiting the linear motion of said end parts in said grooves, allows the grooves to be reopened in order to insert a new shaft in the grooves. Moreover the fact that the grooves face away from the battery compartment, prevents the lid from being drawn out of the groove when the lid is moved from the closed ON-POSITION to the closed OFF-POSITION.

According to a preferred embodiment, said first part is associated with the battery compartment, said second part is associated with the lid and a third part comprises the shaft. This allows the grooves to be formed integrally with the first part which again may be formed integrally with the part closing the hearing aid housing, which is more convenient because there is more room on the closing part than on the lid. The first part may thus be made bigger and sturdier.

According to a preferred embodiment, a central part of said portion of said shaft has a larger cross-sectional dimension than said end parts, said central part having a cross-sectional dimension essentially corresponding to the diameter of said through bore and said end parts having a diameter corresponding essentially to the width of said grooves.

This allows the ends of the shaft protruding from the through bore to flex radially in said bore.

In particular, in a preferred embodiment tapered transition parts are located between said central part and said end parts. Preferably said end parts and said central part are cylindrical and the transition parts frusto-conical. This allows the shaft to have good strength while maintaining the desired flexibility.

In one embodiment said hinge assembly comprises means for securing the lid in the closed ON-POSITION. This prevents inadvertent switching-off of the hearing aid, and consequently the positioning of the lid in a position where it might inadvertently be opened.

In a specific embodiment said means, said first part and said second part comprise a linear cam arrangement with a cam surface and a cam follower. This allows the controlled motion of the lid between at least two stable rest positions, in particular the ON-POSITION and the OFF-POSITION.

In another embodiment said hinge assembly comprises means for securing the lid in the open position. This provides a stable open position, allowing insertion and/or removal of the battery without the lid getting in the way.

In a specific embodiment of said means, said first part and said second part comprise a rotary cam arrangement with a cam surface and a rotary cam follower. This allows the controlled motion of the lid between at least two stable rest positions, in particular the OFF-POSITION and the open position.

In both of said above embodiments, the flexibility of the shaft allows the movement of the cam followers over the cam surfaces between the stable positions, because the flexing thereof allows deflection of the lid in a direction transverse to the linear direction of movement or in a direction perpendicular to the axis of the pivotal motion.

According to a specific embodiment said means for limiting the motion of the end parts, comprise means for closing said grooves at said open ends. This prevents the end parts of the shaft to inadvertently leave the grooves during manipulation of the lid, such as during the ON/OFF switching motion.

According to another preferred embodiment, said means for closing said grooves comprise a fourth part. This part may then conveniently be manufactured as a separate part.

According to a further preferred embodiment, the fourth part comprises snap acting locking means adapted for cooperation with said first part. This is advantageous because it allows an easy assembling of the hinge assembly, while also allowing the assembly to be disassembled for possible repair.

The invention, in a second aspect, provides a method for making a hinge assembly for a hearing aid, said method comprising the steps of providing a shaft having respective end parts, providing a first part comprising a pair of grooves adapted for receiving said respective end parts of said shaft, both of said grooves being open at one end generally facing away from said battery compartment, providing a second part comprising a through bore adapted for receiving a portion of said shaft between said respective end parts, providing a means for closing said grooves at said open ends, inserting said shaft in the trough bore of the second part in such a way that the end parts of said shaft extend from respective ends of said through bore, inserting said end parts of said shaft in respective grooves in the first part, closing said grooves with said means for closing the grooves.

This method constitutes an easy way of assembling the hinge arrangement. This is particularly advantageous if the hinge assembly has to be re-assembled, e.g. after replacement of a broken part thereof

According to a preferred embodiment of the method according to the invention, said closing means is provided as a separate fourth part, and said grooves are closed by means of said fourth part.

This allows the method to be performed manually.

According to a further preferred embodiment of the method according to the invention, said fourth part comprises snap acting locking means adapted for cooperation with said first part, and said fourth part is snapped into engagement with said first part.

This is in particular advantageous in order to allow the manual assembly of the hinge arrangement.

### BRIEF DESCRIPTION OF THE DRAWINGS

The invention will now be described in more detail in conjunction with several embodiments and the accompanying drawings, in which:

FIG. 1 shows a hearing aid with a hinge assembly according to the invention;

FIG. 2 shows a battery compartment for insertion in the hearing aid housing comprising a lid and a hinge assembly according to the invention, the lid being in the closed ON-POSITION;

FIG. 3 shows the battery compartment of FIG. 2 with the lid being in the closed OFF-POSITION;

FIG. 4 shows the battery compartment of FIG. 2 with the lid being in the open OFF-POSITION;

FIG. 5 shows an exploded view of the battery compartment of FIGS. 2 to 4 including the lid and hinge assembly;

FIG. 6 shows a detailed view of the shaft of the hinge assembly according to the invention;

FIG. 7 shows a detailed view of the lid comprising the hinge assembly according to the invention;

FIG. 8 shows a detailed view of the fourth part with snap acting locking means adapted for closing the grooves of the hinge assembly;

FIG. 9 shows a detail view of the battery compartment comprising the hinge assembly of the present invention;

FIG. 10 shows a top plan view of the battery compartment with the fourth part in place but without the lid and the shaft;

FIG. 11 shows a cross section taken along the line XI-XI of FIG. 10; and

FIG. 12 shows a detail view corresponding to the encircled part of FIG. 11.

### DETAILED DESCRIPTION OF THE INVENTION

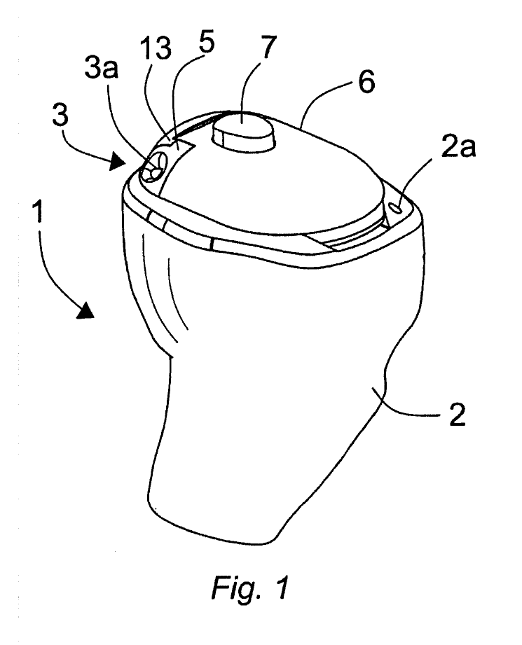

In FIG. 1 is shown a perspective view of an ITE type hearing aid 1. The hearing aid 1 is equipped with a hinge assembly according to the invention. Though an ITE type hearing aid is used to illustrate the invention, it should be noted that the hinge assembly could also be used in other types of hearing aids, such as BTE type hearing aids or CIC type hearings aids. The housing of the hearing aid 1 comprises an earplug 2. The earplug 2 has an open end, in which a closing part 3 comprising the battery compartment 4 is inserted. The closing part 3 comprises a first part 5 of the hinge assembly. The closing part 3 also comprises microphone inlet ports 3a, 3b. The earplug 2 may comprise a vent opening 2a. As an alternative the hearing aid housing could be comprise a further, intermediate part, e.g. a faceplate, the faceplate then having an appropriate cut-out for receiving the closing part. In that case the vent opening would preferably be located in the faceplate. In FIG. 1 the battery compartment 4 is covered by a lid 6, and thus not visible in FIG. 1. In the lid 6 a push-button 7 is located. As can be seen from FIG. 4, 5 or 7, this push-button 7 is associated with switching means 8 allowing e.g. programme selection for the hearing aid 1. The earplug 2, the closing part 3 and the lid 6 are preferably made of the same plastic material e.g. polyoxymethylen (POM), which has good properties regarding resiliency and form stability. The push-button 7 would normally be made of a different material to avoid squeaking when the engaging parts of the lid 6 and the push-button 7 get worn.

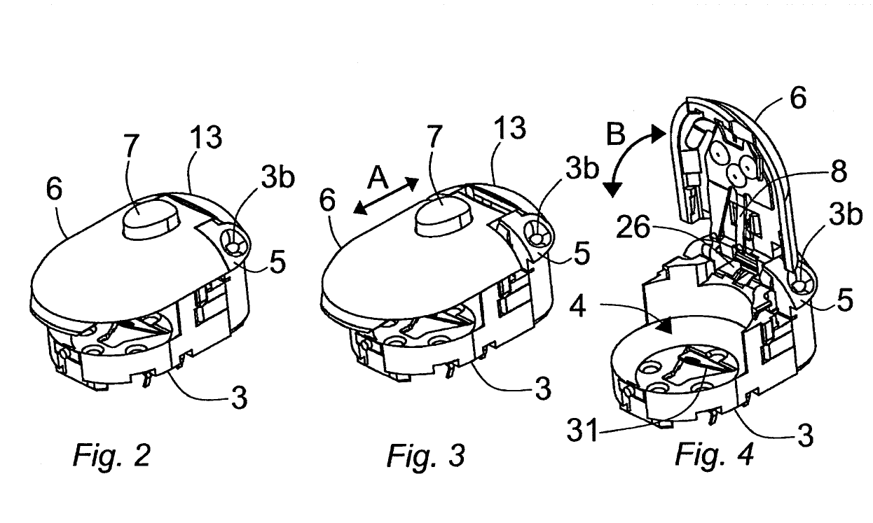

FIGS. 2-4 show the closing part 3 comprising the battery compartment 4. For illustration purposes there is no battery in the battery compartment 4. It also shows the lid 6 in three different positions with respect to the closing part 3. The three different positions correspond to different states, e.g. operation modes, of the hearing aid 1. FIG. 2 corresponds to the hearing aid 1 in a switched-on state. FIG. 3 corresponds to the hearing aid 1 in a switched-off state. FIG. 4 represents an open position where a battery may be inserted in, or has been removed from, the battery compartment 4.

The lid 6 of the hearing aid 1 may be moved linearly between the positions of FIGS. 2 and 3 by the user, as indicated by the double arrow A in FIG. 3. Also, the user may pivot the lid 6 between the positions of FIGS. 3 and 4 as indicated by the double arrow B in FIG. 4. As will be described below, the hinge assembly has means for holding the lid 6 in all three positions of FIGS. 2 to 4.

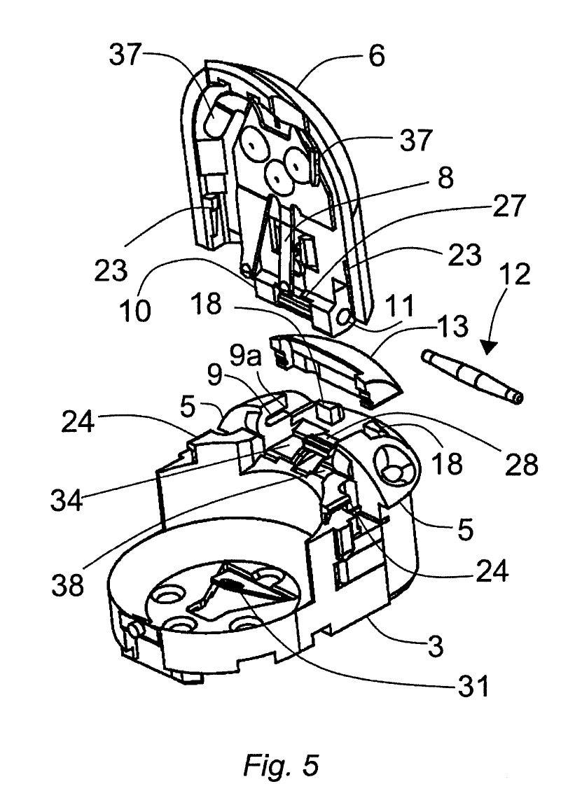

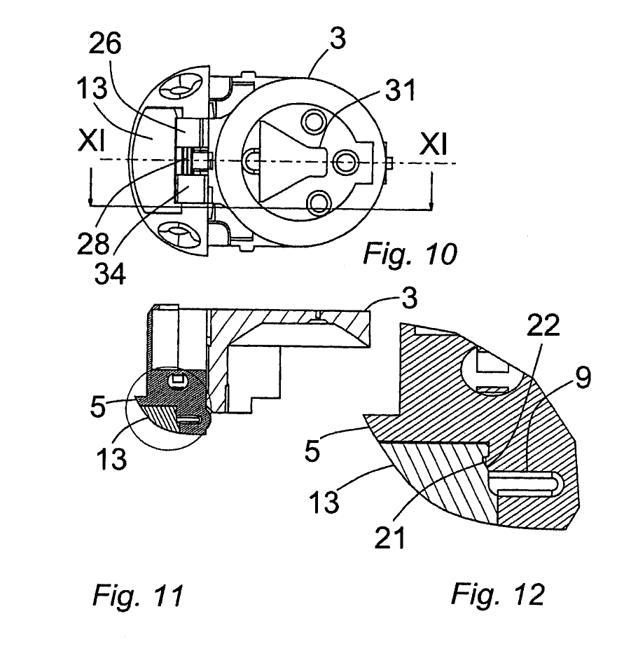

FIG. 5 is an exploded view of the closing part 3 together with the various parts of the hinge assembly including the lid 6. According to the preferred embodiment, the hinge assembly comprises four parts, namely a first part 5, in the form of a bearing block with grooves 9, where the grooves 9 each have at least one open end 9a; a second part 10 comprising a through bore 11; a third part in the form of a shaft 12; and a fourth part 13 adapted to close said grooves 9 at their open ends 9a. The open ends 9a of the grooves 9 generally face in the direction away from the battery compartment 4, i.e. to the left in the plan view of FIG. 10. The first part 5 maybe an integral part of the closing part 3, e.g. moulded as an integral part thereof However, as can best be seen in FIG. 11, the first part 5 and the closing part 3 may be provided as two separate parts. This has the advantage that the one and the same design of the first part 5 may be used with different closing parts. Similarly, the second part 10 may be provided as either a separate part or as an integral part of the lid, e.g. moulded as an integral part thereof The through bore 11 in the second part 10 may be provided during moulding, or it may be drilled subsequently. The through bore 11 is adapted for receiving a middle portion 15, 16 of the shaft 12.

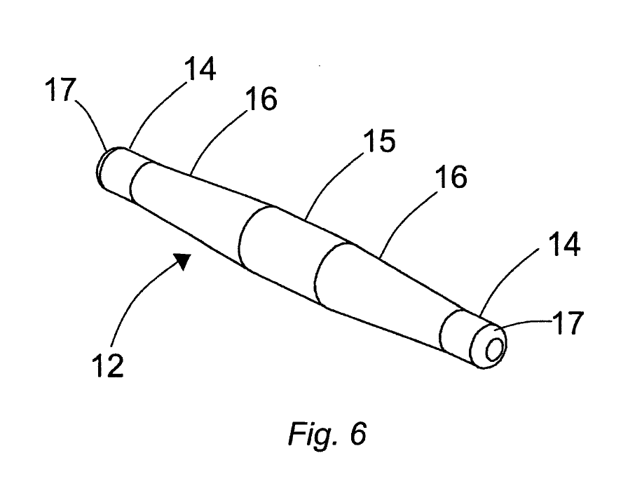

The shaft 12 is shown in greater detail in FIG. 6. Preferably the shaft 12 is made of polyacrylamid (PAA). The shaft 12 has two preferably cylindrical end parts 14. Between the two end parts 14 lies a middle portion 15, 16. The middle portion comprises an essentially cylindrical centre part 15 with a larger diameter than the end parts 14 and two transition parts 16 between the centre part 15 and the respective end parts 14. The diameter of the centre part 15 is preferably selected so that it has a light press fit in the through bore 11, thus securing the shaft 12 against axial movement as well as rotary movement with respect to the through bore 11. Preferably, the transition parts 16 are frusto-conical. Preferably, the shaft 12 is also made of POM.

It should be noted that, because the shaft 12 need not rotate in the through bore 11 neither the central part 15 of the shaft 12 nor the through bore 11 need to be cylindrical. Rather, they may have instead have other cross-sectional shapes than circular, e.g. polygonal. In that case too, the shaft 12 and the through bore 11 preferably have the same cross-sectional shape. Evidently, the transition parts 16 may in that case have a cross section differing from circular, e.g. have the same polygonal cross-section as the centre part 15. In this respect it should also be noted that, the transition parts 16 need not have a taper, but could have the same cross-sectional dimensions along their entire length.

Thus, the cross-sectional dimensions of the centre part 15 of the shaft 12 is adapted to the cross-sectional dimensions of the through bore 10. The diameters of the end parts 14 are adapted to the width of the grooves 9. The length of the shaft 12 is selected so as to allow the end parts 14 to extend from either end of the through bore 11, when the shaft is inserted therein. Preferably, as will be explained below, the tips of the shaft 12 have a chamfer 17.

To assemble the hinge assembly the shaft 12 is inserted into the bore 11, such that the end parts 14 extend from the through bore 11 at both ends thereof The end parts 14 of the shaft 12 are then inserted into the respective grooves 9 in the first part 5 from the open ends 9a. With the ends 14 of the shaft 12 placed in the respective grooves 9, the shaft 12 may now slide freely along the lengths of the grooves 9, as well as rotate therein. Preferably, the shaft 12 may also rotate in the through bore 11 in the second part 10. To prevent the end parts 14 from sliding out of the open ends 9a of the grooves 9, the fourth part 13 is then mounted.

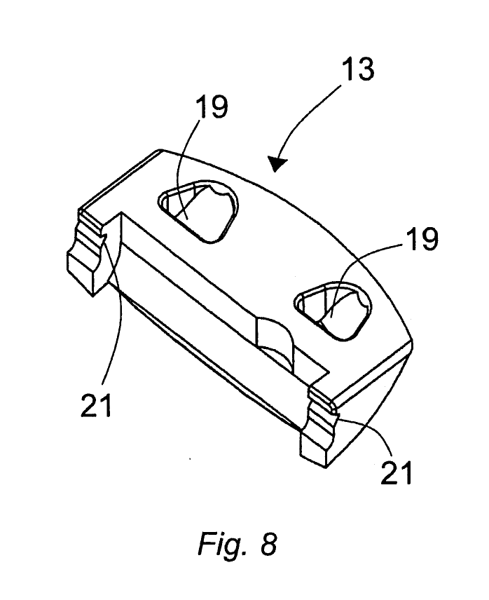

In order to secure the fourth part 13 in the desired place, where it closes the open ends 9a of the grooves 9, it has snap acting locking means cooperating with the first part 5. These are best seen in FIG. 8. The locking means comprises two recesses 19 adapted to fit over corresponding protrusions 18 in the closing part 3, so as to guide the fourth part 13 into the desired position. To secure the fourth part 13 in this desired position it furthermore has two notches 21 in the surfaces which close the grooves 9. These notches cooperate with bosses 22 arranged next to the open ends 9a of the grooves 9. When the recesses 19 of the fourth part are slid over the corresponding protrusions 18, the notches 21 engage their corresponding bosses 22 and secure the fourth part in place. This secured position is shown in the cross sections of FIGS. 11 and 12. If it is necessary to disassemble the hinge arrangement, e.g. for replacement of some broken part thereof, the reverse movement may be effected, thereby disengaging the notches 21 from the bosses 22. With the hinge mounted this way the lid 6 may be moved between the three positions illustrated in FIGS. 2 to 4.

In the closed ON-POSITION of FIG. 2, the lid 6 is secured against rotational movement so as to avoid inadvertent opening of the battery compartment 4. This is effected by means of undercut parts 23 on the lid, which during linear motion of the lid 6 from the position of FIG. 3 to the closed OFF-POSITION of FIG. 2 slide under similar undercut parts 24 on the closing part 3.

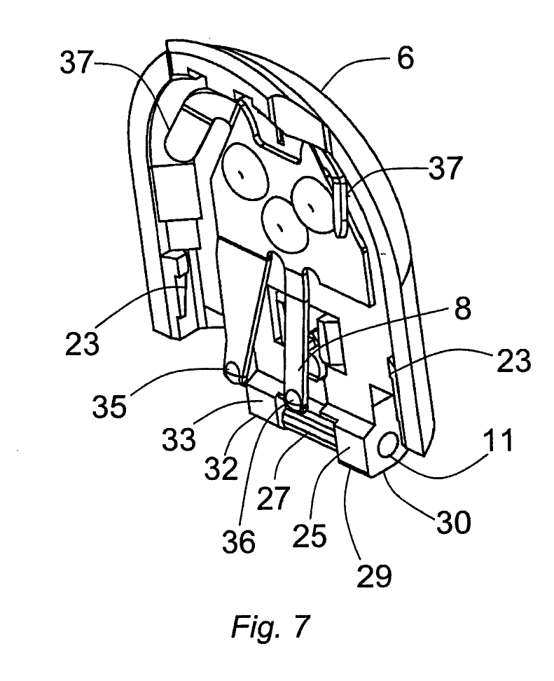

To secure the lid from undesired linear motion, i.e. out of the closed ON-POSITION of FIG. 2 back to the closed OFF-POSITION of FIG. 3, the lid 6 and the closing part 3 have a linear cam arrangement with a cam surface cooperating with a cam follower. In the preferred embodiment, the linear cam follower is provided as a rounded middle part 27 of the second part 10, best seen in FIG. 5 and FIG. 7. During linear motion this rounded middle part 27 is pressed over a raised part 28 forming at least a part of the cooperating cam surface.

The shape of the shaft 12 as described above is adapted to facilitate essentially linear motion of the cam follower along the cam surface. Because the transition parts 16 get narrower towards the ends of the through bore 11, the transition parts 16 of the shaft 12 may flex inside the through bore 11. This allows the lid 6 with the rounded middle part 27 of the second part 10 to be lifted over the raised part 28, without the use of excessive force, while the ends 14 of the shaft 12 remain in the grooves 9. The lid 6 may thus easily be slid between the closed ON-POSITION of FIG. 2 and the closed OFF-POSITION of FIG. 3, and vice versa. Since, during the flexing of the shaft 12, the end parts 14 will tend to engage the sides of the groove 9, the end parts 14 have the chamfer 17 mentioned above.

For securing the lid against undesired rotation in the closed OFF-POSITION of FIG. 3 and the open position of FIG. 4, the lid 6 and the closing part 3 comprise a rotary cam arrangement with a cam surface and a cam follower. Here the flat surface 26 essentially serves as a cam follower in connection with the rotary motion of the lid 6. The cam surface is constituted by the corner 29 between the flat surface 25 and a further flat surface formed between the edge 30 and the corner 29, together with those two surfaces. This further flat surface, which is not visible in any of the figures, has a predetermined angle with respect to the flat surface 25. Preferably this angle is about 90°.

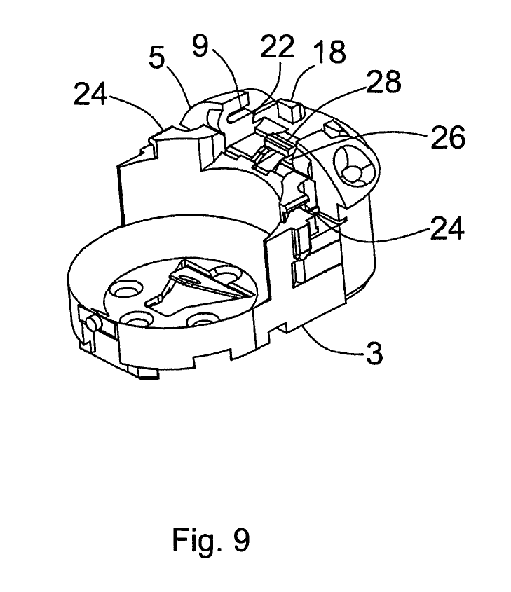

During the rotary motion from the closed OFF-POSITION of the lid 6 to the open position, or vice versa, the corner 29 slides along the flat surface 26, which is best seen in FIG. 9. Since the corner 29 has an increased distance from the centre of the through bore 11, it lifts the lid 6 by flexing the shaft 12 in a manner similar to the one described above in connection with the linear motion. Thus, the lid 6 effects a top-dead-centre motion against the resiliency of the shaft 12, which flexes in the through bore 11, allowing the lid 6 to move from one stable position where the flat surface 25 engages the flat surface 26, and another stable position where the invisible flat surface engages the flat surface 26. Thus, in the closed OFF-POSITION, the lid is prevented from opening forced open by the battery, which is biased towards the lid by a contact spring 31 in the bottom of the battery compartment 4, best seen in FIG. 4 and FIG. 5. In the open position, on the other hand the lid 6 is held in an open position, so as not to interfere with the manipulations of the battery during insertion and removal thereof

In the preferred embodiment, the corner 32 and the surface 33 at the other end of the second part 10 do not constitute or comprise a cam. Rather, as is best seen in FIG. 7, they are located much closer to the centre axis of the through bore 11. This allows the surface 33 to slide over a fixed contact arranged in or on the surface 34 in the closing part 3. The fixed contact is connected to the electronics within the earplug 2 of the hearing aid 1, in order to provide power supply thereof

The lid 6 comprises a number of movable contacts 35, 36, 37. When the lid is closed, the contacts 37 engage the one of the terminals, in the present case the positive terminal, of a battery placed in the battery compartment. As long as the battery lid 6 is closed, the contacts 37 remain in contact with the battery terminal.

When the lid 6 of the hearing aid 1 is moved from the closed OFF-POSITION to the closed ON-POSITION, the surface 33 passes over the surface 34 allowing the contact 35 to engage the fixed contact mounted in or on that surface 34. This closes the supply circuit from the battery to the electronics in the earplug 2 in the hearing aid 1, thus switching the hearing aid 1 on. During the same motion the cam follower 27 is moved past the raised part, thus securing the lid 6 in the ON-POSITION. If the movement is reversed, the lid 6 will move to the OFF-POSITION where the contact 35 does not engage the fixed contact in or on the surface 34.

Similarly, when the lid 6 of the hearing aid 1 is moved from the closed OFF-POSITION to the closed ON-POSITION, the contact 36 of the switching means 8 passes over the surface 38 of the closing part 3, in or on which surface 38 a further fixed contact is mounted. The fixed contact is connected to control circuitry within the hearing aid housing 1 The contact 36, however, does not engage the contact in or on the fixed surface 38 during this motion. The contact 36 may however be brought into engagement with the contact in or on the surface 38, by pressing the push-button 7. When the push-button is released, the contact 36 will move out of engagement with the fixed contact in or on the surface 38, by its own resiliency. Pressing the push-button repeatedly will provide a number of impulses for the control circuitry of the hearing aid 1, thereby allowing e.g. change of programme.

1. A hinge assembly for a lid of a battery compartment of a hearing aid, comprising a first part, a second part and a third part, said third part having a shaft, said first part having a pair of grooves adapted for receiving respective end parts of said shaft, so as to allow the shaft to slide along the lengths of said grooves, both of said grooves being open at one end generally facing away from said battery compartment,
said second part having a through bore adapted for receiving a portion of said shaft between said respective end parts, wherein a central part of said portion of said shaft has a larger cross-sectional dimension than said end parts, said central part having a cross-sectional dimension essentially corresponding to the cross-sectional dimension of said through bore and said end parts having a diameter corresponding essentially to the width of said grooves, and
said hinge assembly further having means for limiting the linear motion of said end parts of said shaft in said grooves.

2. The hinge assembly according to claim 1, wherein said first part is associated with the battery compartment, and said second part is associated with the lid.

3. The hinge assembly according to claim 1, comprising tapered transition parts located between said central part and said end parts.

4. The hinge assembly according to claim 3, wherein said end parts and said central part are cylindrical, and said transition parts are frusto-conical.

5. The hinge assembly according to claim 1, comprising means for securing the lid in the closed ON-POSITION.

6. The hinge assembly according to claim 5, wherein said first part and said second part comprise a linear cam arrangement with a cam surface and a cam follower.

7. The hinge assembly according to claim 1, comprising means for securing the lid in the open position.

8. The hinge assembly according to claim 7, wherein said first part and said second part comprise rotary cam arrangement with a cam surface and a rotary cam follower.

9. The hinge assembly according to claim 1, wherein said means for limiting the motion of the end parts, comprise means for closing said grooves at said open ends.

10. The hinge assembly according to claim 9 wherein said means for closing said grooves comprise a fourth part.

11. The hinge assembly according to claim 10, wherein said fourth part is provided as a separate part.

12. The hinge assembly according to claim 10, wherein said fourth part comprises snap acting locking means adapted for cooperation with said first part.

13. A method for making a hinge assembly for a hearing aid, said method comprising the steps of providing a shaft having respective end parts, providing a first part comprising a pair of grooves adapted for receiving said respective end parts of said shaft, both of said grooves being open at one end generally facing away from said battery compartment, providing a second part comprising a through bore adapted for receiving a portion of said shaft between said respective end parts, providing a means for closing said grooves at said open ends, inserting said shaft in the trough bore of the second part in such a way that the end parts of said shaft extend from respective ends of said through bore, inserting said end parts of said shaft in respective grooves in the first part, closing said grooves with said means for closing the grooves.

14. The method according to claim 13, wherein said closing means is provided as a separate fourth part, and wherein said grooves are closed by means of said fourth part.

15. The method according to claim 14, wherein said fourth part comprises snap acting locking means adapted for cooperation with said first part, and wherein said fourth part is snapped into engagement with said first part.
